(19) United States
(12) Patent Application Publication
(10) Pub. No.: US 2025/0372896 A1
(43) Pub. Date: Dec. 4, 2025

(54) TERMINAL-FITTED ELECTRIC WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); SUMITOMO ELECTRIC FINE POLYMER, INC., Sennan-gun, Osaka (JP)

(72) Inventors: Yusaku MAEDA, Yokkaichi-shi (JP); Kazuo NAKASHIMA, Yokkaichi-shi (JP); Taro FUJITA, Osaka-shi (JP); Shigeyuki TANAKA, Osaka-shi (JP); Ryota FUKUMOTO, Osaka-shi (JP); Yasutaka EMOTO, Sennan-gun (JP); Mamoru SEKIGUCHI, Sennan-gun (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP); SUMITOMO ELECTRIC FINE POLYMER, INC., Sennan-gun, Osaka (JP)

(21) Appl. No.: 18/874,171

(22) PCT Filed: Jun. 1, 2023
(86) PCT No.: PCT/JP2023/020405

§ 371 Date: Dec. 12, 2024

(30) Foreign Application Priority Data
Jun. 20, 2022 (JP) 2022-099051

(51) Int. Cl. H01R 4/70

(52) U.S. Cl. CPC H01R 4/70; H01R 2201/26

(57) ABSTRACT

A terminal-fitted electric wire includes: a wire portion including a terminal fitting, an insulated electric wire including a conductor and an insulation covering, and an electrical connection portion in which the terminal fitting and the insulated electric wire are electrically connected to each other; a tube member covering the outer circumference of the insulation covering in a part along the insulated electric wire; and a resin coat covering a part of the wire portion which includes the electrical connection portion of the wire portion and is in contact with at least a part of an outer surface of the tube member. The tube member is formed as a single-layered cylinder including a crosslinked polyolefin resin, and an acid-modified resin in an amount 5-40 parts by mass of resin ingredients, and a thermoplastic elastomer in an amount of 20-40 parts by mass of the resin ingredients.

### TECHNICAL FIELD

The present disclosure relates to a terminal-fitted electric wire.

### BACKGROUND ART

An insulated electric wire that is routed in a vehicle such as an automobile often has a terminal fitting that is connected to a conductor at an end of the wire. If electrolyte liquid such as water comes into contact with an electrical connection portion where the terminal fitting and the conductor are electrically connected, electrical problems such as short circuits and corrosion of metal materials may occur. To prevent the electrical problems and corrosion, it is necessary to take a waterproofing measure to the electrical connection portion.

A known waterproofing measure for the electrical connection portion is covering the electrical connection portion with a resin coat such as a molded material. The resin coat is formed in an area extending from the electrical connection portion to a part of a terminal end of the insulated electric wire. Meanwhile, if a gap is formed between the resin coat and the insulated electric wire, liquids such as water may intrude through the gap, causing electrical problems such as short circuits and corrosion of metal materials in the electrical connection portion. One method that is sometimes used to prevent intrusion of the liquids through the gap is to have a layer of an adhesive agent interposed between the insulated electric wire and the resin coat. For example, Patent Document 1 discloses a structure having an adhesive layer which is formed on a surface of an insulation coating at an end of an insulated wire, and a waterproof resin portion (i.e., a resin coat) formed to include a part in which the adhesive layer is formed. A tube member such as a heat-shrinkable tube may be used instead of the adhesive agent. For example, Patent Document 2 discloses a structure having an adhesive tube provided to cover an end of an insulator of an insulated electric wire, and a mold portion (i.e., a resin coat) formed to include a region covering the adhesive tube. The adhesive tube in Patent Document 2 is made from a thermoplastic resin having a cross-linked structure and has heat shrinkability.

### CITATION LIST

### Patent Literature

Patent Document 1: JP 2013-187041 A
Patent Document 2: JP 2019-091639 A

### SUMMARY OF INVENTION

### Technical Problem

When a liquid adhesive is used to provide water sealability of the resin coat as disclosed in Patent Document 1, the liquid adhesive may cause inconveniences, such as a thickness of the liquid adhesive being easily varied and a solvent contained in the liquid adhesive requiring a long time to dry. Furthermore, from the viewpoint of following a difference in thermal expansion between the insulation covering of the insulated electric wire and the resin coat, it is required to form a layer of the liquid adhesive to be thick; meanwhile, it is difficult to form a thick layer using the liquid adhesive. In contrast, if the tube member such as the heat-shrinkable tube is used instead of the adhesive agent as disclosed in Patent Document 2, it is possible to place easily a layer having a sufficient thickness and excellent thickness uniformity between the resin coat and the insulated electric wire.

In Patent Document 2, examples of materials constituting the adhesive tube include a thermoplastic resin having a crosslinked structure, particularly a synthetic resin mainly composed of a polyolefin resin such as crosslinked polyethylene or crosslinked polypropylene. It is said that adhering an outer surface of the adhesive tube to an inner surface of the molded portion can prevent the intrusion of the liquids. However, in automobile, particularly a high level of water sealability may be required depending on an application of a terminal-fitted electric wire and a part where the terminal-fitted electric wire is placed. By further examining a material constituting the adhesive tube of those described in Patent Document 2, it may be possible to achieve a higher level of water sealability.

In view of the foregoing, an object of the present disclosure is to provide a terminal-fitted electric wire that can improve water sealability of a resin coat covering an electrical connection portion between a terminal fitting and an insulated electric wire without using a liquid adhesive.

### Solution to Problem

A terminal-fitted electric wire includes a wire portion. The wire portion includes a terminal fitting, an insulated electric wire including a conductor and an insulation covering coating an outer circumference of the conductor, and an electrical connection portion in which the terminal fitting and the insulated electric wire are electrically connected to each other. The terminal-fitted electric wire further includes a tube member covering an outer circumference of the insulation covering in a part along an axial direction of the insulated electric wire, and a resin coat that covers a part of the wire portion which includes the electrical connection portion and is in contact with at least a part of an outer surface of the tube member. The tube member is formed as a single-layered cylindrical member including a crosslinked polyolefin resin, and at least one of an acid-modified resin in an amount of 5 parts by mass or larger and 40 parts by mass or smaller of resin ingredients, and a thermoplastic elastomer in an amount of 20 parts by mass or larger and 40 parts by mass or smaller of the resin ingredients.

### Advantageous Effects of Invention

A terminal-fitted electric wire according to the present disclosure provides a terminal-fitted electric wire that can improve water sealability of a resin coat covering an electrical connection portion between a terminal fitting and an insulated electric wire without using a liquid adhesive.

### BRIEF DESCRIPTION OF DRAWINGS

FIG. 1 is a perspective side view showing a terminal-fitted electric wire according to an embodiment of the present disclosure, in which a tube member is indicated by dashed lines.

FIG. 2 is a partial cross-sectional view of the terminal-fitted electric wire, in which the tube member and a resin coat are cut.

### DESCRIPTION OF EMBODIMENTS

### Description of Embodiments of Present Disclosure

First, embodiments of the present disclosure will be explained.

(1) A terminal-fitted electric wire includes a wire portion. The wire portion includes a terminal fitting, an insulated electric wire including a conductor and an insulation covering coating an outer circumference of the conductor, and an electrical connection portion in which the terminal fitting and the insulated electric wire are electrically connected to each other. The terminal-fitted electric wire further includes a tube member covering an outer circumference of the insulation covering in a part along an axial direction of the insulated electric wire, and a resin coat that covers a part of the wire portion which includes the electrical connection portion and is in contact with at least a part of an outer surface of the tube member. The tube member is formed as a single-layered cylindrical member including a crosslinked polyolefin resin, and at least one of an acid-modified resin in an amount of 5 parts by mass or larger and 40 parts by mass or smaller of resin ingredients, and a thermoplastic elastomer in an amount of 20 parts by mass or larger and 40 parts by mass or smaller of the resin ingredients.

In the terminal-fitted electric wire mentioned above, the tube member is interposed between the resin coat covering the electrical connection portion connecting the terminal fitting and the insulated electric wire, and the insulated electric wire. Since the tube member contains at least one of the acid-modified resin and the thermoplastic elastomer in the specified amounts mentioned above, in addition to the crosslinked polyolefin resin, the tube member exhibits high adhesiveness to the insulation covering and the resin coat. Therefore, the resin coat is firmly adhered to the insulated electric wire via the tube member.

Consequently, intrusion of the liquids such as water is less likely to occur through a region between the resin coat and the insulated electric wire. As a result, in the terminal-fitted electric wire, water sealability provided by the resin coat is effectively improved by the tube member. The tube member also has excellent manufacturability.

(2) In the embodiment (1) described above, the tube member should contain both the acid-modified resin and the thermoplastic elastomer. This feature increases the adhesiveness between the tube member, the insulation covering, and the resin coat, and increases the water sealability.

(3) In the embodiment (1) or (2) described above, the thermoplastic elastomer and the resin material constituting the resin coat should have a same type of skeleton. Having the same type of skeleton particularly increases the adhesiveness of the tube member to the resin coat and is highly effective in improving the water sealability.

(4) In any one of the embodiments (1) to (3) described above, the thermoplastic elastomer should contain at least one of a polyester-based elastomer and a polyamide-based elastomer. This feature allows the tube member to exhibit high adhesiveness to the insulation covering and the resin coat. A molded material provided on the terminal-fitted electric wire may often contain a polyester resin and a polyamide resin. When the resin coat is formed as the molded material containing any of these resin materials, the tube member containing the elastomer mentioned above exhibits particularly high adhesiveness to the molded material, effectively suppressing the intrusion of the liquids through the region between the resin coat and the insulated electric wire.

(5) In any one of the embodiments (1) to (4) described above, the acid-modified resin should contain an acid-modified polyolefin resin. This feature makes it easier to form the tube member that exhibits high adhesiveness to the insulation covering and the resin coat, together with the crosslinked polyolefin resin.

(6) In any one of the embodiments (1) to (5) described above, the resin coat should cover an outer surface of the tube member over the entire region of the tube member. In this case, the entire tube member is to be placed at a region between the resin coat and the insulated electric wire, contributing to improved adhesive force between the resin coat and the insulated electric wire.

### Detailed Description of Embodiments of Present Disclosure

A detailed description of a terminal-fitted electric wire according to an embodiment of the present disclosure will now be provided, referring to the drawings. Unless otherwise specified, various properties below are values measured at room temperature and in air.

### <Overall Structure>

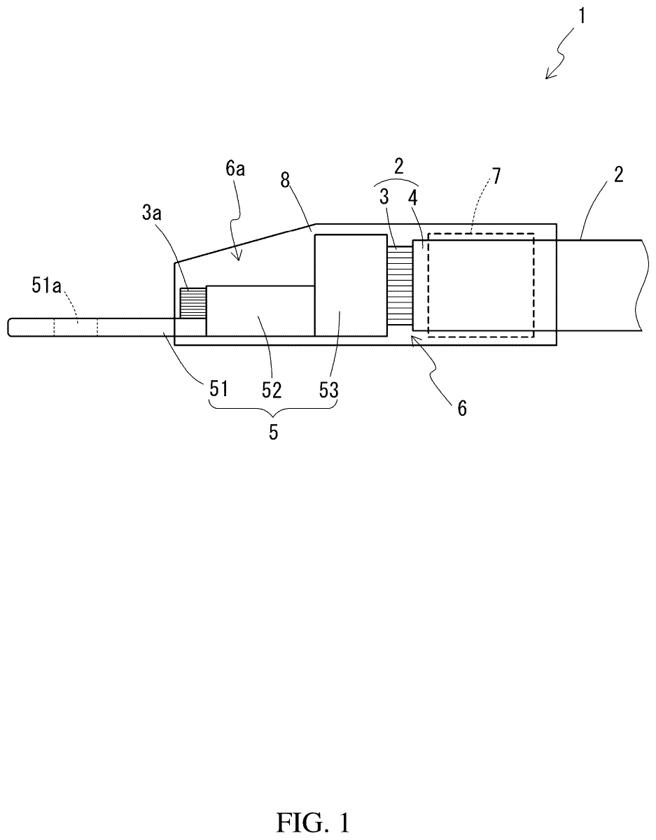

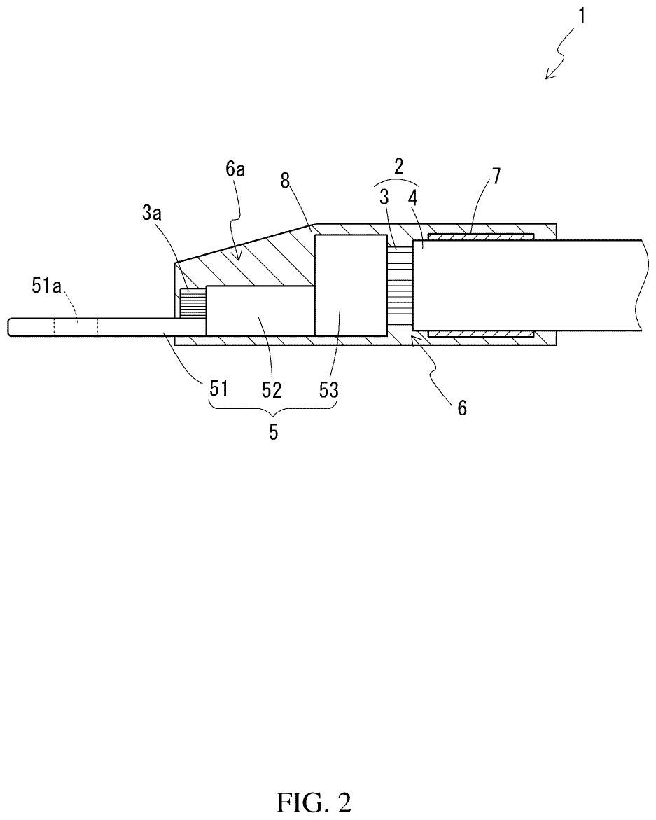

First, an overall structure of a terminal-fitted electric wire 1 according to one embodiment of the present disclosure will be described with reference to FIGS. 1 and 2. The terminal-fitted electric wire 1 has a wire portion 6, a tube member 7, and a resin coat 8. In FIG. 1, the terminal-fitted electric wire 1 is shown in a perspective side view. Here, the tube member 7 is shown by dashed lines. In FIG. 2, the terminal-fitted electric wire 1 is shown in a partial cross-sectional view in which only the tube member 7 and the resin coat 8 are cut.

The wire portion 6 includes an insulated electric wire 2 including a conductor 3 and an insulation covering 4 coating the conductor 3, a terminal fitting 5, and an electrical connection portion 6a in which the insulated electric wire 2 and the terminal fitting 5 and are electrically connected to each other. The terminal fitting 5 has a terminal connection portion 51 and a barrel portion including a first barrel portion 52 and a second barrel portion 53 which are formed integrally and extend from a rear end of the terminal connection portion 51. The terminal connection portion 51 is constituted as a bolt-fastening type connection portion, and can be electrically connected to a counterpart conductive member by using a bolt inserted into a bolt insertion hole 51a.

In the electrical connection portion 6a, the insulation covering 4 at a terminal end of the insulated electric wire 2 is removed, and the conductor 3 is exposed. The terminal end of the insulated electric wire 2 at which the conductor 3 is exposed is crimped and fixed to one surface (i.e., an upper surface in FIGS. 1 and 2) of the barrel portions 52, 53 of the terminal fitting 5, making the insulated electric wire 2 connected to the terminal fitting 5. Specifically, the first barrel portion 52 connects electrically the conductor 3 and the terminal fitting 5, and fixes physically the conductor 3 to the terminal fitting 5. Meanwhile, the second barrel portion 53 fixes the insulated electric wire 2 positioned to the rear of the first barrel portion 52 and supports the insulated electric wire 2 to be fixed physically to the terminal fitting 5. In the present specification, a direction where the terminal fitting 5 is located along an axial direction (i.e., a longitudinal direction) of the terminal-fitted electric wire 1 is defined as a front, and a direction where the insulated electric wire 2 is located is defined as a rear.

The tube member 7 is formed as a single-layered cylindrical member made of a specific material described later. The tube member 7 covers an outer circumference of the insulation covering 4 in a part along an axial direction of the insulated electric wire 2. In the illustrated embodiment, the tube member 7 covers a region near the terminal end of the insulated electric wire 2 around the entire circumference.

The resin coat 8 is formed as a coating layer made of a resin material such as a molded material, and covers a part including the electrical connection portion 6a in the wire portion 6. The resin coat 8 is in contact with at least a part of an outer surface of the tube member 7. In the illustrated embodiment, the resin coat 8 covers the outer surface of the tube member 7 over the entire region of the tube member. The resin coat 8 is formed along the axial direction of the terminal-fitted electric wire 1, over a region extending from the front of a front end 3a of the conductor 3 exposed at the terminal end of the insulated electric wire 2 to the rear of a front end of the insulation covering 4 of the insulated electric wire 2. Namely, the resin coat 8 covers an entire region of the electrical connection portion 6a and a partial region where the insulation covering 4 of the insulated electric wire 2 remains unremoved, over the entire circumference. The region where the resin coat 8 covers the insulation covering 4 of the insulated electric wire 2 also includes a region where the tube member 7 is provided.

Thus, the tube member 7 is placed to cover the outer circumference of the insulation covering 4 of the insulated electric wire 2, and the outer circumference of the insulation covering 4 is further covered with the resin coat 8. The tube member 7 is made of a single-layered material, and no other material such as an adhesive is interposed between the tube member 7 and the insulation covering 4, or between the tube member 7 and the resin coat 8. The tube member 7 is adhered on its inner surface to an outer surface of the insulation covering 4, and is adhered on its outer surface to an inner surface of the resin coat 8. Here, the adhesion of the inner and outer surfaces of the tube member 7 to the insulation covering 4 and the resin coat 8 is achieved by welding (i.e., fusion). Namely, the material constituting the single-layered material of the tube member 7 melts and then solidifies again on its inner and outer surfaces, and in the depth regions near the surfaces, to thereby adhere to the insulation covering 4 and the resin coat 8 over the entire circumference.

In the terminal-fitted electric wire 1 according to the present embodiment, the resin coat 8 covers the electrical connection portion 6a of the wire portion 6 over the entire region of the electrical connection portion 6a. Therefore, the electrical connection portion 6a is protected from contact with liquids such as water by the resin coat 8. Furthermore, the tube member 7 is interposed between the resin coat 8 and the insulated electric wire 2, and is adhered to both the resin coat 8 and the insulated electric wire 2. Therefore, the resin coat 8 is stuck to the outer circumference of the insulation covering 4 through the tube member 7. Consequently, the presence of the tube member 7 prevents intrusion of the liquids such as water into the electrical connection portion 6a through a region between the resin coat 8 and the insulation covering 4. Namely, the tube member 7 plays a role in improving water sealability of the terminal-fitted electric wire 1. In particular, the tube member 7 is made of a specific material to be described later. Therefore, the tube member 7 exhibits excellent adhesion to the insulation covering 4 and the resin coat 8, and is highly effective in improving the water sealability. The resin coat 8 and the tube member 7 suppress the intrusion of an electrolyte such as water into the electrical connection portion 6a. Consequently, electrical problems such as short circuits and corrosion of metal materials are less likely to occur at the electrical connection portion 6a.

### <Constitution of Each Part>

Specific constitutions of the wire portion 6, the resin coat 8, and the tube member 7 that compose the terminal-fitted electric wire 1 will be described below in order.

### (Wire Portion)

As described above, the wire portion 6 has a structure in which the terminal fitting 5 is connected to the end portion of the insulated electric wire 2 via the electrical connection portion 6a.

The conductor 3 included in the insulated electric wire 2 may be made of a single metal wire, but is preferably made of stranded wires in which a plurality of elemental wires are twisted together. In this case, the stranded wires may be made of one type of metal wire or two or more types of metal wires. Examples of materials for the metal wires constituting the conductor 3 include copper, copper alloys, aluminum, aluminum alloys, and plated materials to these materials.

Examples of materials constituting the insulation covering 4 composing the insulated electric wire 2 include rubbers, polyolefin resins such as polyethylene (PE) and polypropylene (PP), halogen polymers such as polyvinyl chloride (PVC), and thermoplastic elastomers. These may be used alone or in combination of two or more. The resin materials may be crosslinked. Various additives may be added to the material constituting the insulation covering 4 as appropriate. Examples of the additives include flame retardants, fillers, and colorants.

Examples of materials (i.e., base materials) for the terminal fitting 5 include various copper alloys, copper, etc., in addition to commonly used brass. A part (a contact part, for example) or an entire of the surface of the terminal fitting 5 may be plated with various metals such as tin, nickel, gold, or alloys including these metals.

As described above, the conductor 3 and the terminal fitting 5 may be made of any metal material. However, corrosion is particularly likely to occur at the electrical connection portion 6a due to contact with the electrolyte such as moisture, when different types of metals are in contact at the electrical connection portion 6a, as exemplified in a case where the terminal fitting 5 is made of a commonly used material constituting a terminal, the material made of a base material made of copper or a copper alloy plated with tin, and the conductor 3 includes the elemental wire made of aluminum or an aluminum alloy. However, the terminal-fitted electric wire 1 according to the present embodiment includes a water-sealing structure in which the resin coat 8 covers the electrical connection portion 6a, and the tube member 7 is interposed between the resin coat 8 and the insulated electric wire 2, which can also suppress such corrosion between dissimilar metals.

### (Resin Coat)

As described above, the resin coat 8 covers the electrical connection portion 6a between the terminal fitting 5 and the conductor 3, thereby preventing the intrusion of the liquids such as water into the electrical connection portion 6a from the outside. As shown in FIGS. 1 and 2, the resin coat 8 contacts the surface of the terminal fitting 5 at a front portion and contacts the insulation covering 4 of the insulated electric wire 2 and the tube member 7 at a rear portion, thereby covering the entire area of the electrical connection portion 6a.

The area in which the resin coat 8 is located is not particularly specified, as long as the resin coat 8 covers the entire electrical connection portion 6a along an axial direction of the wire portion 6 and in contact with at least a part of the outer surface of the tube member 7. Specifically, the resin coat 8 may cover only a part of the outer surface of the tube member 7 on a front part along the front-rear direction, or may cover the entire outer surface of the tube member 7. However, as shown in the figure, it is preferable that the resin coat 8 covers the entire outer surface of the tube member 7 along the front-rear direction and along a circumferential direction. In this case, the tube member 7 is in contact with the resin coat 8 and is adhered to the resin coat 8 over the entire outer surface of the tube member, and therefore, an adhesive force between the resin coat 8 and the insulated electric wire 2 is enhanced. As a result, the tube member 7 serves to enhance the effect of suppressing the intrusion of the liquids through a region between the resin coat 8 and the insulated electric wire 2.

The material constituting the resin coat 8 is not particularly limited, and various resin materials can be applied. Among various resin materials, a polyester resin such as polybutylene terephthalate (PBT) and a polyamide resin such as aromatic nylon can be used preferably. These resins can firmly suppress the intrusion of the liquids such as water and also exhibit high mechanical strength. The resin material constituting the resin coat 8 may be only one kind, or two or more kinds may be mixed. Various additives may be added to the material of the resin coat 8 as appropriate. Examples of the additives include flame retardants, fillers, and colorants.

The resin coat 8 made of the polyester resin or the polyamide resin exhibits high adhesiveness to surfaces of the metal materials such as the terminal fitting 5 and the conductor 3. Therefore, in the electrical connection portion 6a, the resin coat 8 sticks directly to the surfaces of these metal materials, thereby strongly suppressing the intrusion of the liquids from the outside. On the other hand, the resin coat 8 made of these resins is less likely to exhibit high adhesiveness to the insulation covering 4 made of a resin such as polyolefin or PVC. However, in the terminal-fitted electric wire 1 according to the present embodiment, the tube member 7 that exhibits the adhesiveness to both the insulation covering 4 and the resin coat 8 is interposed between the insulation covering 4 and the resin coat 8 in a rearward part of the resin coat 8, and the insulation covering 4 and the resin coat 8 are adhered to each other via the tube member 7.

The resin coat 8 may be placed at a predetermined position by any method, such as coating or molding of a molten resin. However, the resin coat 8 is preferably configured as a molded material formed by molding of the molten resin. The resin coat 8 containing the polyester resin or the polyamide resin can be suitably formed as the molded material.

### (Tube Member)

The tube member 7 is configured as an insulating resin member having a cylindrical shape previously placed on an outer circumference of the insulated electric wire 2. The tube member 7 is formed as a single-layered cylindrical member, and not provided with any layer other than the cylindrical member, such as a layer of a liquid adhesive.

The material constituting the tube member 7 includes a crosslinked polyolefin resin, and at least one of an acid-modified resin and the thermoplastic elastomer. Preferably, the tube member 7 contains at least the acid-modified resin in addition to the crosslinked polyolefin resin. More preferably, the tube member 7 contains both the acid-modified resin and the thermoplastic elastomer in addition to the crosslinked polyolefin resin. As described above, the tube member 7 is formed to have a single layer and the resins are uniformly mixed and molded.

The crosslinked polyolefin resin is a resin in which a crosslinked structure is formed between polymer chains of a polyolefin resin. Examples of the polyolefin resins constituting the crosslinked polyolefin resin include homopolyolefins such as polyethylene (PE) and polypropylene (PP), block polyolefin such as an ethylene-propylene copolymer, and an ethylene copolymer. In particular, it is preferable to employ polyolefin such as PE. As the polyolefin resin, only one type may be used or two or more kinds may be mixed. The polyolefin resin is not acid-modified, unlike the acid-modified resin described next. The crosslinked polyolefin resin exhibits a certain degree of adhesiveness to the insulation covering 4 and the resin coat 8 by welding.

The crosslinking of the polyolefin resin is preferably carried out by irradiation with ionizing radiation, particularly with electron beams. Alternatively, crosslinking methods other than by the ionizing radiation, such as silane crosslinking, may be used. In the tube member 7, the crosslinking may be carried out to a mixture of the polyolefin resin and the acid-modified resin and/or the thermoplastic elastomer described above.

When the tube member 7 contains the crosslinked polyolefin resin, the tube member 7 can be formed as a heat-shrinkable tube. Specifically, a resin composition containing an olefin resin are subjected to extrusion molding into a small-diameter tube, thereafter, the small-diameter tube is subjected to the crosslinking by electron beam irradiation and then the small-diameter tube is subjected to diameter expansion while being heated, whereby heat shrinkability is imparted to the tube member 7. When the tube member 7 formed as the heat-shrinkable tube is placed at a predetermined position on the insulated electric wire 2 and heated to be shrunk, the tube member 7 can be placed to stick to an outer surface of the insulated electric wire 2. During the heating process, an inner surface of the tube member 7 can be welded to the surface of the insulation covering 4 simultaneously with the shrinkage of the tube member 7.

The content of the crosslinked polyolefin resin in the tube member 7 is not particularly limited. However, from the viewpoint of ensuring manufacturability of the tube member 7, the crosslinked polyolefin resin should be the main component of resin ingredients constituting the tube member 7. Specifically, it is preferable that the crosslinked polyolefin resin occupies 50 mass % or more of the resin ingredients constituting the tube member 7. In particular, it is preferable that the crosslinked polyolefin resin occupies 60 mass % or more and 95 mass % or less of the resin ingredients constituting the tube member 7. Furthermore, it is preferable that the crosslinked polyolefin resin makes up the remainder of the resin ingredients constituting the tube member 7, other than the acid-modified resin and the thermoplastic elastomer. In the present specification, the content of each component constituting the tube member 7, expressed in units of parts by mass, refers to the amount of the resin ingredients (i.e, polymer ingredients) of the material constituting the tube member 7.

As described above, it is preferable that the material constituting the tube member 7 includes the acid-modified resin. A type of resin composing the acid-modified resin is not particularly limited, but a polyolefin resin or other thermoplastic resin can be used preferably. Examples of the polyolefin resins include homopolyolefins such s polyethylene (PE) and polypropylene (PP), block polyolefin such as the ethylene-propylene copolymer, and the ethylene copolymer. As the thermoplastic resin other than the polyolefin resin, styrene resin such as a styrene-ethylene-butylene-styrene block copolymer (SEBS) can be used preferably. In particular, the polyolefin such as PP is preferably used from the viewpoint of affinity with the crosslinked polyolefin resin. Only one type of the acid-modified resin may be used, or two or more types may be mixed.

If the material constituting the tube member 7 includes the acid-modified resin in addition to the crosslinked polyolefin resin, the tube member 7 has high adhesiveness to the insulation covering 4 and the resin coat 8. In particular, when the resin coat 8 contains the polyester resin or the polyamide resin, which have polar structures, the tube member 7 exhibits high adhesiveness to the resin coat 8 due to the interaction between the polar structure and an acid-modified moiety of the acid-modified resin.

The content of the acid-modified resin in the material constituting the tube member 7 is preferably 5 parts by mass or more from the viewpoint of achieving the effect of improving the adhesiveness sufficiently. More preferably, the content of the acid-modified resin is 10 parts by mass or more, or 20 parts by mass or more. Meanwhile, if the content of the acid-modified resin is too high, the material constituting the tube member 7 becomes brittle, and thus damage such as tearing may occur during the manufacturing process of the tube member 7 including the extrusion molding and diameter expansion. As a result, manufacturing of the tube member 7 can become difficult. From the viewpoint of ensuring the manufacturability of the tube member 7, the content of the acid-modified resin is preferably suppressed to 40 parts by mass or lower, and more preferably to 30 parts by mass or lower.

The material constituting the tube member 7 is preferably include the thermoplastic elastomer in addition to or instead of the acid-modified resin. The thermoplastic elastomer is not particularly limited to a specific type as long as it is an elastomer, namely, a polymer having a hard segment and a soft segment. The adhesiveness of the tube member 7 to the insulation covering 4 and the resin coat 8 is improved mainly due to the contribution of the soft segment contained in the thermoplastic elastomer. Unlike the acid-modified resin mentioned above, the thermoplastic elastomer is not acid-modified.

In particular, it is preferable that the thermoplastic elastomer contains at least one of a polyester-based elastomer that has the hard segment composed of polyester units and a polyamide-based elastomer that has the hard segment composed of polyamide units. These thermoplastic elastomers are highly effective in improving the adhesiveness of the tube member 7. In particular, it is preferable that the thermoplastic elastomer has a same type of skeleton as that of the resin material forming the resin coat 8. For example, when the resin coat 8 contains the polyester resin such as PBT, the polyester-based elastomer is preferably used for the tube member 7. Also, when the resin coat 8 contains the polyamide resin such as the aromatic nylon, the polyamide-based elastomer may be used for the tube member 7. When the thermoplastic elastomer 9 contained in the tube member 7 and the resin material constituting the resin coat 8 have the same type of skeleton as exemplified above, the adhesiveness of the tube member 7 to the resin coat 8 can be improved particularly effectively.

The content of the thermoplastic elastomer in the material constituting the tube member 7 is preferably 20 parts by mass or higher from the viewpoint of obtaining the effect of improving the adhesiveness sufficiently. More preferably, the content is 30 parts by mass or higher. On the other hand, from the viewpoint of ensuring the manufacturability of the tube member 7, the content of the thermoplastic elastomer is preferably suppressed to 40 parts by mass or lower.

Both the acid-modified resin and the thermoplastic elastomer have the effect of increasing the adhesiveness of the tube member 7 to the insulation covering 4 and the resin coat 8, especially to the resin coat 8. If the material constituting the tube member 7 contains at least one of the acid-modified resin and the thermoplastic elastomer, the effect of improving the adhesiveness is exhibited. However, the material constituting the tube member 7 preferably contains at least the acid-modified resin among them. This is because the effect of improving the adhesiveness of the tube member 7 can be obtained, even if the amount of the acid-modified resin is relatively small. Furthermore, it is most preferable that the tube member 7 contains both the acid-modified resin and the thermoplastic elastomer. In this case, both the acid-modified resin and the thermoplastic elastomer contribute to improve the adhesiveness of the tube member 7 particularly effectively. It is particularly preferable that the total content of the acid-modified resin and the thermoplastic resin in the material constituting the tube member 7 is 30 parts by mass or higher and 45 parts by mass or lower.

The material constituting the tube member 7 may contain a polymer component other than the crosslinked polyolefin resin, acid-modified resin, and thermoplastic elastomer mentioned above. However, the polymer component other than those resins is preferably kept lower in content than those resins not to impair the properties of those resins. It is preferable that a polymer material constituting the tube member 7 does not contain the polymer component other than the crosslinked polyolefin resin, acid-modified resin, and thermoplastic elastomer. The material constituting the tube member 7 may contain additives as appropriate, in addition to the polymer material. Examples of the additives include flame retardants, fillers, and colorants.

A wall thickness of the tube member 7 is not particularly limited, but from the viewpoints of enhancing the effect of improving the water sealability and sufficiently following a difference in thermal expansion between the insulation covering 4 and the resin coat 8, it is preferable that the wall thickness of the tube member 7 is set to 50 μm or more, and even 100 μm or more. Meanwhile, from the viewpoint of preventing a portion including the water-sealing structure of the terminal-fitted electric wire 1 from being excessively large, it is preferable that the wall thickness of the tube member 7 is suppressed to 2 mm or less, and even preferably 1 mm or less. The thickness described here refers to the thickness after the tube member is thermally shrunk.

As described in the foregoing, in the terminal-fitted electric wire 1 according to the present embodiment, the tube member 7 is located between the resin coat 8 that covers the region including the electrical connection portion 6a and the insulation covering 4 of the insulated electric wire 2, and the tube member 7 exhibits the adhesiveness to the insulation covering 4 and the resin coat 8. Thus, the resin coat 8 is adhered to the insulated electric wire 2 via the tube member 7. When the tube member 7 contains at least one of the acid-modified resin and the thermoplastic elastomer in addition to the crosslinked polyolefin resin, the adhesiveness of the tube member 7 is improved, and the tube member 7 exhibits high adhesiveness particularly to the resin coat 8. The high adhesiveness of the tube member 7 contributes to preventing the intrusion of the liquids such as water through the region between the resin coat 8 and the insulation covering 4 toward the electrical connection portion 6a. By protection of the electrical connection portion 6a from being contact with the electrolyte such as water, electrical problems such as the short circuits or the corrosion of the metal materials are suppressed, and a favorable electrical connection is maintained for a long period of time in the electrical connection portion 6a. Since the tube member 7 is formed as a single-layered cylindrical member having high adhesiveness, there is no need to use the liquid adhesive to improve the water sealability. The use of the tube member 7 allows a simple arrangement of the resin material having a sufficient thickness at a specified location of the terminal-fitted electric wire 1 with high uniformity, unlike a case of the liquid adhesive being used.

In the tube member 7, the contents of the acid-modified resin and the thermoplastic elastomer are preferably suppressed to 40 parts by mass or lower, respectively, as described above, from the viewpoint of ensuring the manufacturability in the manufacturing processes of the tube member 7 including the extrusion molding and diameter expansion. As an index of the manufacturability of the tube member 7, breaking elongation of the material constituting the tube member 7 can be used. Specifically, it is preferable that the material constituting the tube member 7 has the breaking elongation of 150% or higher, and more preferably 300% or higher. The breaking elongation can be evaluated by a tensile test in accordance with JIS K 7161.

### <Manufacturing Method of Terminal-Fitted Electric Wire>

Finally, a method for manufacturing the terminal-fitted electric wire 1 according to the present embodiment will be described. First, a method for manufacturing the tube member 7 will be described. For the manufacturing of the tube member 7, the resin composition is prepared by kneading the polyolefin resin, at least one of the acid-modified resin and the thermoplastic resin, and various additives as necessary. Then, the resin composition is extruded into a cylindrical shape. The obtained cylindrical body is crosslinked by the electron beam irradiation to form the tube member 7. When the tube member 7: is configured as the heat-shrinkable tube, the resin composition should be extruded into a small diameter, crosslinked by the electron beam irradiation, and then subjected to the diameter expansion while being heated, and thereafter cooled. These processes allow the tube member 7 to memorize the shape before subjected to the diameter expansion and acquire the heat shrinkability. The inner diameter of the heat-shrinkable tube should be smaller than the outer diameter of the insulated electric wire 2 before being subjected to the diameter expansion, and is made larger than the outer diameter of the insulated electric wire 2 by the diameter expansion.

For the manufacturing of the terminal-fitted electric wire 1, the wire portion 6 is first prepared. Specifically, the barrel portions 52, 53 of the terminal fitting 5 are crimped and fixed to the terminal end of the insulated electric wire 2 at which the insulation covering 4 has been stripped off. Through this process, the conductor 3 and the terminal fitting 5 get connected to each other at the electrical connection portion 6a. Depending on the specific structure of the terminal fitting 5, the conductor 3 and the terminal fitting 5 may be connected by other methods such as ultrasonic welding, or soldering, instead of crimping. In any of the methods, the insulated electric wire 2 is inserted into a hollow portion of the tube member 7 cut to a required length before or after the terminal fitting 5 is fixed to the insulated electric wire 2. The tube member 7 is thus placed around the outer circumference of the insulated electric wire 2.

Next, the tube member 7 is heated after located at a predetermined position near the terminal end of the insulated electric wire 2. When the tube member 7 is configured as the heat-shrinkable tube, the tube member 7 shrinks by the heating and sticks to the outer circumference of the insulated electric wire 2. At the same time, the material constituting the inner surface of the tube member 7 is welded to the insulation covering 4 by heating, thereby the tube member 7 is adhered to the insulation covering 4. The tube member 7 can be heated by ultrasonic welding, vibration welding, high-frequency welding, laser welding, infrared welding, friction welding, hot-plate welding, or hot-air welding.

Next, the resin coat 8 is formed on the wire portion 6 with the tube member 7 by covering a predetermined part of the wire portion 6 including the electrical connection portion 6a. The resin coat 8 can be formed by placing a molten resin material at the predetermined part and solidifying the molten resin material. The resin material can be preferably placed by molding. Specifically, the resin material can be molded by preparing a die with a cavity having a shape corresponding to a shape of the resin cover 8, accommodating the predetermined part including the electrical connection portion 6a and an area in the wire portion 6 where the tube member 7 is placed, and thereafter, injecting the molten resin material into the die. The resin material is solidified, whereby the resin coat 8 formed as a molded material can be obtained. As a high-temperature molten resin comes into contact with the outer surface of the tube member 7 during the formation of the resin coat 8, the heat causes the material constituting the outer surface of the tube member 7 to be welded to the inner surface of the resin coat 8. As a result, the tube member 7 is adhered to the resin coat 8.

### EXAMPLE

A description of examples will now be presented. In the examples, the properties of the tube member, such as water sealability of the terminal-fitted electric wire, were evaluated while changing a material constituting the tube member. It should be noted that the present disclosure is not limited to the examples. In the examples, the properties were evaluated at room temperature in the air.

### [Preparation of Samples]

For each of Samples A1 to A27 and B1 to B9, a heat-shrinkable tube member containing the components listed in Tables 1 to 3 was prepared. For preparation of the tube member, a resin composition prepared by kneading of the components in Tables 1 to 3 was extruded into a small-diameter cylindrical shape, crosslinked by electron beam irradiation, and then subjected to diameter expansion. The heat-shrinkable tube member was made to have an outer diameter of 6.4 mm and a wall thickness of 0.5 mm in the state after the diameter expansion. For samples using non-crosslinked PE as a material of Group a, the resin composition was directly extruded to the dimensions mentioned above without the electron beam irradiation. For samples using a silane-crosslinked PE, the resin composition was extruded to the dimensions mentioned above and then silane crosslinked. An electron-beam crosslinked PE1 and an electron-beam crosslinked PE2 are both electron-beam crosslinked polyethylenes, but crosslinking degrees are different from each other, and the electron-beam crosslinked PE2 has a lower crosslinking degree.

An insulated electric wire was prepared by forming an insulation covering composed of a crosslinked polyethylene resin around an outer surface of a conductor composed of a copper alloy stranded wire. An outer diameter of the insulated electric wire was 5.3 mm. The insulation covering a terminal end of the insulated electric wire was removed to expose the conductor, a male crimp terminal fitting made of tin-plated brass, which is widely used for automobiles, was crimped and fixed to the terminal end of the electric wire, and a wire portion was obtained. Furthermore, the tube member having a length of 10 mm was previously placed on an outer periphery of the insulated electric wire composing the wire portion at a position near the terminal end of the insulated electric wire.

Next, each sample was placed in a thermostatic bath to heat the tube member. At this time, the tube member that has the heat shrinkability was thermally shrunk and stuck to the outer circumference of the insulated electric wire. A wall thickness of the tube member was 0.6 mm after heat shrinkage.

Finally, a resin coat was formed by molding. As a material constituting the resin coat, PBT or nylon 6T (i.e., PA6T) was used. As shown in FIGS. 1 and 2, the resin coat was formed to cover an entire electrical connection portion between the insulated electric wire and the terminal fitting, and further to cover an entire outer surface of the tube member.

### [Evaluation of Properties]

### (1) Water Sealability

Each of the terminal-fitted electric wires provided with various tube members prepared as described above was subjected to an air leak test for evaluation of water sealability. Specifically, an entire part covered with the resin coat in each terminal-fitted electric wire was immersed in water, and a predetermined air pressure was applied from the terminal end to which the terminal fitting was not connected. During application of the air pressure, air leakage was checked by inspecting visually whether air bubbles were generated at an interface between the insulation covering and the resin coat of the insulated electric wire. This test was carried out while changing the air pressure to be applied. The water sealability was evaluated based on the upper limit of the air pressure at which no air leakage was observed.

The water sealability was evaluated according to the following criteria:
“Very high water sealability (A+)” was given when the upper limit of the air pressure was 200 kPa or higher;
“High water sealability (A)” was given when the upper limit of the air pressure was 100 kPa or higher but lower than 200 kPa;
“Low water sealability (B)” was given when the upper limit of the air pressure was 50 kPa or higher but lower than 100 kP; and
“Very low water sealability (B−)” was given when the upper limit of the air pressure was lower than 50 kPa.

### (2) Heat Shrinkability of Tube Member

The presence (A) or absence (B) of heat shrinkability of each tube member was determined based on whether or not the tube member was shrunk by heat when the tube member placed around the outer circumference of the insulated electric wire was heated in the manufacturing process of the terminal-fitted electric wire.

### (3) Manufacturability of Tube Member

As an index indicating the manufacturability of each tube member, each material constituting the tube member was subjected to a measurement of breaking elongation. If the material constituting the tube member is brittle and has small breaking elongation, damage such as tearing may occur during the extrusion molding or diameter expansion, which reduces the manufacturability of the tube member. The breaking elongation was measured by a tensile test in accordance with JIS K 7161.

The manufacturability of each tube member was evaluated based on a measured value of the breaking elongation as follows:
“Very high manufacturability (A+)” was given when the breaking elongation was 300% or more
“High manufacturability (A)” was given when the breaking elongation was 150% or more and less than 300%
“Low manufacturability (B)” was given when the breaking elongation was less than 150%.

### [Evaluation Results]

Tables 1 to 3 below show a composition of the tube member, the material constituting the resin coat, and the evaluation results of the properties for each of Samples A1 to A27 and B1 to B9. For the composition of each tube member, contents of the resin ingredients are shown in mass 8. For the resin coat, either PBT or PA6T used as a material constituting the resin coat was marked with a black circle.

TABLE 1

| | | | Sample No. | | | | | | | | | | |
|---|---|---|---|---|---|---|---|---|---|---|---|---|---|
| | | | A1 | A2 | A3 | A4 | A5 | A6 | A7 | A8 | A9 | A10 | A11 |
| Composition | a | Electron-beam | 90 | 90 | 80 | | 70 | 60 | | 60 | 60 | 60 | 60 |
| of Tube | | crosslinked PE1 | | | | | | | | | | | |
| Member | | Electron-beam | | | | | | | 90 | | | | |
| | | crosslinked PE2 | | | | | | | | | | | |
| | | Silan-Crosslinked | | | | 80 | | | | | | | |
| | | PE | | | | | | | | | | | |
| | | Non-crosslinked | | | | | | | | | | | |
| | | PE | | | | | | | | | | | |
| | | Crosslinked | | | | | | | | | | | |
| | | Silicone | | | | | | | | | | | |
| | b | Acid-modified | 10 | | | | | | | | | | |
| | | SEBS | | | | | | | | | | | |
| | | Acid-modified PP | | 10 | 20 | 20 | 30 | 40 | 10 | | | | |
| | | Unmodified PP | | | | | | | | | | | |
| | c | Polyester-based | | | | | | | | 40 | | 40 | |
| | | Thermoplastic | | | | | | | | | | | |
| | | Elastomer | | | | | | | | | | | |
| | | Polyamide-based | | | | | | | | | 40 | | 40 |
| | | Thermoplastic | | | | | | | | | | | |
| | | Elastomer | | | | | | | | | | | |

| | | | | | | | | | | | | |
|---|---|---|---|---|---|---|---|---|---|---|---|---|
| Resin | PBT | ● | ● | ● | ● | ● | ● | ● | ● | ● | | |
| Coat | PA6T | | | | | | | | | | ● | ● |
| Property | Water-Sealability | A | A | A | A | A | A | A | A | A | A | A |
| Evaluation | Thermal-Shurinkability | A | A | A | A | A | A | A | A | A | A | A |
| Results | of Tube Member | | | | | | | | | | | |
| | Manufacturability of | A+ | A+ | A+ | A+ | A+ | A+ | A | A | A | A | A |
| | Tube Member | | | | | | | | | | | |

TABLE 2

| | | | Sample No. | | | | | | | | | | | | | | | |
|---|---|---|---|---|---|---|---|---|---|---|---|---|---|---|---|---|---|---|
| | | | A12 | A13 | A14 | A15 | A16 | A17 | A18 | A19 | A20 | A21 | A22 | A23 | A24 | A25 | A26 | A27 |
| Compo- | a | Electron-beam | 60 | 60 | 65 | 65 | 60 | 60 | 65 | 65 | 60 | 60 | 65 | 65 | 60 | 60 | 65 | 65 |
| sition | | crosslinked PE1 | | | | | | | | | | | | | | | | |
| of Tube | | Electron-beam | | | | | | | | | | | | | | | | |
| Member | | crosslinked PE2 | | | | | | | | | | | | | | | | |
| | | Silan-Crosslinked | | | | | | | | | | | | | | | | |
| | | PE | | | | | | | | | | | | | | | | |
| | | Non-crosslinked | | | | | | | | | | | | | | | | |
| | | PE | | | | | | | | | | | | | | | | |
| | | Crosslinked | | | | | | | | | | | | | | | | |
| | | Silicone | | | | | | | | | | | | | | | | |
| | b | Acid-modified | | | | | | | | | | | | | | | | |
| | | SEBS | | | | | | | | | | | | | | | | |
| | | Acid-modified PP | 20 | 10 | 15 | 10 | 20 | 10 | 15 | 10 | 20 | 10 | 15 | 10 | 20 | 10 | 15 | 10 |
| | | Unmodified PP | | | | | | | | | | | | | | | | |
| | c | Polyester-based | 20 | 30 | 20 | 25 | | | | | 20 | 30 | 20 | 25 | | | | |
| | | Thermoplastic | | | | | | | | | | | | | | | | |
| | | Elastomer | | | | | | | | | | | | | | | | |
| | | Polyamide-based | | | | | 20 | 30 | 20 | 25 | | | | | 20 | 30 | 20 | 25 |
| | | Thermoplastic | | | | | | | | | | | | | | | | |
| | | Elastomer | | | | | | | | | | | | | | | | |

| | | | | | | | | | | | | | | | | | |
|---|---|---|---|---|---|---|---|---|---|---|---|---|---|---|---|---|---|
| Resin | PBT | ● | ● | ● | ● | ● | ● | ● | ● | | | | | | | | |
| Coat | PA6T | | | | | | | | | ● | ● | ● | ● | ● | ● | ● | ● |
| Property | Water-Sealability | A+ | A+ | A+ | A+ | A | A+ | A | A | A | A+ | A | A | A+ | A+ | A+ | A+ |
| Evaluation | Thermal- | A | A | A | A | A | A | A | A | A | A | A | A | A | A | A | A |
| Results | Shurinkability | | | | | | | | | | | | | | | | |
| | of Tube Member | | | | | | | | | | | | | | | | |
| | Manufacturability of | A+ | A+ | A+ | A+ | A+ | A+ | A+ | A+ | A+ | A+ | A+ | A+ | A+ | A+ | A+ | A+ |
| | Tube Member | | | | | | | | | | | | | | | | |

TABLE 3

| | | | Sample No. | | | | | | | | |
|---|---|---|---|---|---|---|---|---|---|---|---|
| | | | B1 | B2 | B3 | B4 | B5 | B6 | B7 | B8 | B9 |
| Composition | a | Electron-beam | 100 | | | | 90 | | | 95 | 50 |
| of Tube | | crosslinked PE1 | | | | | | | | | |
| Member | | Electron-beam | | | | | | | | | |
| | | crosslinked PE2 | | | | | | | | | |
| | | Silan-Crosslinked | | 100 | | | | | | | |
| | | PE | | | | | | | | | |
| | | Non-crosslinked | | | 100 | | | 80 | | | |
| | | PE | | | | | | | | | |
| | | Crosslinked | | | | 100 | | | 80 | | |
| | | Silicone | | | | | | | | | |
| | b | Acid-modified | | | | | | | | | |
| | | SEBS | | | | | | | | | |
| | | Acid-modified PP | | | | | | 20 | 20 | 5 | 50 |
| | | Unmodified PP | | | | | 10 | | | | |
| | c | Polyester-based | | | | | | | | | |
| | | Thermoplastic | | | | | | | | | |
| | | Elastomer | | | | | | | | | |
| | | Polyamide-based | | | | | | | | | |
| | | Thermoplastic | | | | | | | | | |
| | | Elastomer | | | | | | | | | |

| | | | | | | | | | | |
|---|---|---|---|---|---|---|---|---|---|---|
| Resin | PBT | ● | ● | ● | ● | ● | ● | ● | ● | ● |
| Coat | PA6T | | | | | | | | | |
| Property | Water-Sealability | B− | B− | B− | B− | B− | A | B− | B | A |
| Evaluation | Thermal-Shurinkability | A | A | B | A | A | B | A | A | A |
| Results | of Tube Member | | | | | | | | | |
| | Manufacturability of | A+ | A+ | A+ | A+ | A+ | A+ | A+ | A+ | B |
| | Tube Member | | | | | | | | | |

All tube members of Samples A1 to A27 shown in Tables 1 and 2 above contain at least one of an acid-modified resin (Group b) in an amount of 5 parts by mass or larger and 40 parts by mass or smaller of the resin ingredients, and a thermoplastic elastomer (Group c) in an amount of 20 parts by mass or large and 40 parts by mass or smaller of the resin ingredients, in addition to a crosslinked polyolefin resin (Group a). Since the tube members contain the crosslinked polyolefin resin, the tube members of any samples have the heat shrinkability (i.e., evaluated as A). Furthermore, corresponding to the fact that all tube members contain at least one of the acid-modified resin and the thermoplastic elastomer in the specified amounts mentioned above, high water sealability (A or A+) and high manufacturability of the tube member (A or A+) are obtained.

Meanwhile, in Samples B1 to B9 listed in Table 3, since each tube member does not have the composition containing the crosslinked polyolefin resin and at least one of the acid-modified resin and thermoplastic elastomer in the specified amounts, each tube member does not satisfy sufficiently at least one of the water sealability, heat shrinkability of the tube member, and manufacturability of the tube member. In Samples B3 and B6, since non-crosslinked resins are used as resins of Group a and the tube members do not contain crosslinked resins, the tube members do not have the heat shrinkability (B). Sample B7 has a crosslinked silicone resin instead of the crosslinked polyolefin resin as the crosslinked resin, and the tube member shows the heat shrinkability (A), but the water sealability was evaluated as very low (B−). The fact is considered to be because the crosslinked silicone resin does not show high adhesiveness to the insulation covering of the insulated electric wire.

Samples B1 to B5 show very low water sealabilities (B−), since the tube members do not contain either the acid-modified resin or the thermoplastic elastomer. In Sample B8, the tube member contains the acid-modified resin, however, the amount thereof is smaller than 10 parts by mass, and the Sample B8 shows low water sealability (B). In Sample B9, the tube member contains the acid-modified resin in an amount over 40 parts by mass, and the tube member of Sample 9 shows low manufacturability (B).

Then, Samples A1 to A27 are compared with each other. First, in regard to the crosslinked polyolefin resin of Group a, a comparison between Sample A3 and Sample A4 shows that they have equivalent water sealability (A) and the manufacturability of the tube member (A+) with each other, regardless of whether the crosslinking is carried out by electron beam crosslinking or silane crosslinking. Furthermore, a comparison between Sample A2 and Sample A7 shows that Sample A2, which uses the electron beam crosslinked PE1 having a higher crosslinking density, has particularly high manufacturability.

The tube member in each of Samples A1 to A11 contains only one of either the acid-modified resin or thermoplastic elastomer, while the tube member in each of Samples A12 to A27 contains both of them. While Samples A1 to A11 are all no more than evaluated as having high water sealability (A), most of Samples A12 to A27 are evaluated to have very high water sealability (A+). The results indicate that the use of both the acid-modified resin and thermoplastic elastomer for the tube member is highly effective in improving the water sealability.

A comparison between Sample A1 and Sample A2 shows that either acid-modified SEBS or acid-modified PP used as the acid-modified resin is effective in improving the water sealability. The evaluation result of the water sealability of each sample also shows that either a polyester-based or a polyamide-based thermoplastic elastomers is effective in improving the water sealability. However, each of Samples A12 to A15 in which both of the thermoplastic elastomer contained in the tube member and the resin material constituting the resin coat have polyester skeletons, and each of Samples A24 to A27 in which both of them have polyamide skeletons tends to have generally higher water sealability than each of Samples A16 to A23 in which the thermoplastic elastomer and the resin material have different types of skeletons with each other. This fact indicates that the effect of improving the water sealability can be achieved sufficiently by using a thermoplastic elastomer having the same type of skeleton as that of the resin material constituting the resin coat, as the thermoplastic elastomer added to the tube material.

Although the embodiments of the present disclosure have been described in detail above, the present invention is not limited to the embodiments described above, and various modifications are possible without departing from the gist of the present invention.

### DESCRIPTION OF REFERENCE NUMERALS

1 Terminal-fitted electric wire
2 Electric wire
3 Conductor
3a Front end of conductor
4 Insulation covering
5 Terminal fitting
51 Terminal connection portion
51a Bolt insertion hole
52 First barrel portion
53 Second barrel portion
6 Wire part
6a Electrical connection portion
7 Tube member
8 Resin coat

1. A terminal-fitted electric wire, comprising:
a wire portion, comprising:
a terminal fitting;
an insulated electric wire comprising a conductor and an insulation covering coating an outer circumference of the conductor; and
an electrical connection portion in which the terminal fitting and the insulated electric wire are electrically connected to each other;
a tube member covering an outer circumference of the insulation covering in a part along an axial direction of the insulated electric wire; and
a resin coat that covers a part of the wire portion which includes the electrical connection portion and is in contact with at least a part of an outer surface of the tube member, wherein
the tube member is formed as a single-layered cylindrical member comprising:
a crosslinked polyolefin resin; and
at least one of:
an acid-modified resin in an amount of 5 parts by mass or larger and 40 parts by mass or smaller of resin ingredients; and
a thermoplastic elastomer in an amount of 20 parts by mass or larger and 40 parts by mass or smaller of the resin ingredients.

2. The terminal-fitted electric wire according to claim 1, wherein the tube member comprises both the acid-modified resin and the thermoplastic elastomer.

3. The terminal-fitted electric wire according to claim 1, wherein the thermoplastic elastomer and a resin material constituting the resin coat have same type of skeletons.

4. The terminal-fitted electric wire according to claim 1, wherein the thermoplastic elastomer comprises at least one of a polyester-based elastomer and a polyamide-based elastomer.

5. The terminal-fitted electric wire according to claim 1, wherein the acid-modified resin comprises an acid-modified polyolefin resin.

6. The terminal-fitted electric wire according to claim 1, wherein the resin coat covers an entire outer surface of the tube member.
